(19) United States
(12) Patent Application Publication
(10) Pub. No.: US 2008/0052766 A1
(43) Pub. Date: Feb. 28, 2008

(54) Method and a system for managing secure transmission

(75) Inventors: Jean-Francois Esperet, Nouvoitou (FR); Pascal Hingant, Melesse (FR)

Correspondence Address: COHEN PONTANI LIEBERMAN & PAVANE LLP, Suite 1210, 551 Fifth Avenue, New York, NY, 10176, US

(73) Assignee: France Telecom, Paris (FR)

(21) Appl. No.: 11/827,640

(22) Filed: Jul. 12, 2007

(30) Foreign Application Priority Data
Jul. 12, 2006 (FR) 06/52936

(51) Int. Cl. H04L 9/00

(52) U.S. Cl. 726/3

(57) ABSTRACT

System and method of management of secure transmission to a remote unit. The system includes a session manager adapted to receive from a communications terminal a request for connection to a defined remote unit and adapted to create and simultaneously and automatically manage a secure working session with said terminal and said remote unit and further includes a security device corresponding to said defined remote unit and adapted to set up simultaneously and automatically a communication session and then said secure working session with said session manager. The system and method can make transmission to a remote unit secure without user intervention.

The present invention relates to a method and a system for managing secure transmission to a remote unit.

The invention applies more particularly to making transmission to a remote unit secure automatically, without user intervention.

### BACKGROUND OF THE INVENTION

At present, a user can manage a unit remotely from a communications terminal connected to a public telecommunications network. To make such communication secure, remote access is generally effected via a packet-switched network using a standardized X25 protocol to protect transmission between the terminal and the remote unit. Calls over an X25 network are made secure by the Intelligent Network (IN) architecture. Users who subscribe to that network are grouped into Closed User Groups (CUG). Calls are authorized only for users of the same CUG. Security is intrinsic to the X25 network, which is a closed and protected network. CUGs are part of the X25 protocol and the parameters of X25 network subscribers include the CUG to which they belong. A terminal of a subscriber to the X25 network must be in the same CUG as the remote unit it wishes to access. The X25 network is old, however, and is presently being run down. Access to it is not guaranteed from all geographical areas. Moreover, if the X25 network is down, no alternative transmission solution using a secure network is possible.

Remote access for managing a remote unit can also be based on a public telephone network. Security then covers only setting up the connection, for example by calling the telephone number of a local terminal that manages the remote unit. At the time the connection is set up, protection is provided following reception of the connection request by an automatic call back mechanism. However, once the connection has been set up, the call and the transmission of data over the public telephone network are not protected.

### OBJECTS AND SUMMARY OF THE INVENTION

One object of the present invention is to provide a method and a system for managing secure transmission to a remote unit that eliminate the drawbacks of existing systems by allowing connection from an unsecured telecommunications network as well as guaranteeing the reliability and the confidentiality of transmission to said remote unit.

These and other objects are attained in accordance with one aspect of the present invention directed to a method of managing secure transmission to a remote unit, comprising the steps of:
connecting at least a terminal to at least a session manager to define at least a remote unit;
said session manager automatically commanding opening of a communication session for setting up a connection to at least a security device connected to said defined remote unit;
said session manager automatically checking at least a security application of the terminal to create at least a first secure transmission tunnel;
said session manager creating at least a secure working session with said security device; and
transmitting data between the terminal and the remote unit.

Another aspect of the invention is directed to a system for managing secure transmission to a remote unit, which system includes:
at least a session manager adapted to receive from at least a communications terminal at least a request for connection to at least a defined remote unit and adapted to create and simultaneously and automatically manage at least a secure working session with said terminal and said remote unit; and
at least a security device corresponding to said defined remote unit and adapted to set up simultaneously and automatically at least a communication session and then said secure working session with said session manager.

In one embodiment of the invention, said session manager creates said first secure transmission tunnel to said terminal for each communication session.

In one embodiment of the invention, said session manager creates a second secure transmission tunnel to said security device for each communication session.

The invention can provide a technical architecture for managing secure transmissions and a simple management method without user intervention by virtue of being automated by a session manager.

Thus said management system and method enable a communications terminal to set up a connection to a remote unit and to transmit data to the unit via said session manager. For each data transmission required, the session manager sets up and manages a communication session with a security device corresponding to the defined remote unit. The session manager then creates for each communication session a first secure tunnel for transmission to a security application of the communications terminal. Said session manager also creates a second transmission tunnel to said security device connected to said defined remote unit.

In one embodiment, each secure working session with a security device is identified by a communication session.

The session manager manages the separation and the compartmentalization of the connections and transmissions set up to the same security device and connections and transmissions to other security devices.

In one particular embodiment, said session manager creates one or more communication sessions with different security devices.

In this way, the session manager of the invention enables independent and simultaneous management of different communication sessions and secure working sessions corresponding to the various terminals and the various remote units via an unsecured public telecommunications network.

In one embodiment of the invention, said session manager simultaneously creates one or more communication sessions and one or more secure working sessions with one or more security devices, separately or in combination.

In one particular embodiment, said session manager creates one or more secure working sessions for a communication session.

The session manager and the security device enable multisession operation of the system and the method of the invention. Multiple remote units can be connected to the same security device. Similarly, multiple communications terminals and/or multiple security devices can be connected to a session manager.

Moreover, once a communication session between a session manager and a security device has been set up, multiple secure working sessions with various communications terminals and/or various remote units can be set up using that communication session.

### BRIEF DESCRIPTION OF THE ONLY DRAWING

FIG. 1 represents the general architecture of a system in accordance with an embodiment of the invention for managing secure transmission to a remote unit.

### DETAILED DESCRIPTION OF THE ONLY DRAWING

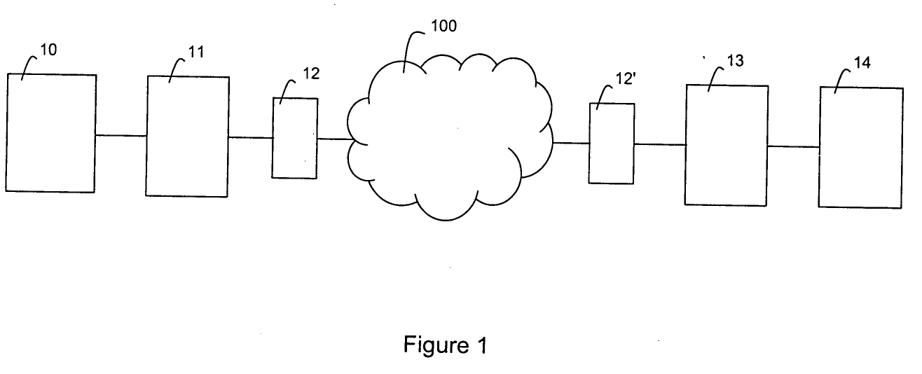

A management system of the invention represented in FIG. 1 for secure transmission to a remote unit 14 from a communications terminal 10 includes a session manager 11 and a security device 13.

The management system also includes a database for storing all data necessary for said system to operate. Said database can be physically included in the management system or not, and in particular it can be included in said session manager 11.

Moreover, it includes a modem 12, 12′ for modulating and demodulating data transmitted by said management system during secure transmission. Said modem 12, 12′ can be physically included in said management system or not, and in particular it can be included in said session manager 11 or said security device 13.

One or more communications terminals 10 distributed between different sites in different geographical areas can be connected to one or more modems 12. Similarly, one or more security devices 13 distributed between sites in different geographical areas can be connected to one or more modems 12′.

The communications terminal 10 is a terminal of any kind, such as a personal computer (PC), a supervisor console, a data processing machine, a control terminal, etc., and transmits data to a telecommunications network 100 and to a session manager 11. Said terminal 10 is configured with a security software application, such as a SSH (Secure SHell) protocol application, that is used to create a secure data transmission session. The terminal is configured to use said security application to create a secure transmission tunnel to a session manager 11. Said security application monitors transmission of data by a secure working session to a security device 13 connected to a remote unit 14.

Similarly, a remote unit 14 can be of various kinds, for example a network unit such as a router or a switch, an electronic data processing unit, a relay control unit, for example a unit for controlling an air conditioner or heater, or any home automation control unit and the like, or any unit having a local operating console. In particular, remote management enables display of the operating status of the unit, transmission of a command, modification of the configuration of the unit, etc.

Said telecommunications network 100 is a public network, transmission over which is not secure (the network is not closed and/or not protected), such as a telephone network or STN (switched telephone network), an ADSL (asymmetric digital subscriber line) transmission network, an ATM transmission network, etc.

Said session manager 11 is adapted to receive a connection request in respect of a remote unit 14 defined by a communications terminal 10. The session manager 11 is configured to manage and store an identification of said connection in a database and to transmit data to the security device 13 connected to the remote unit 14. The session manager 11 can in particular be an Internet site or any other communication server that the user of the terminal 10 can access. The session manager unit 11 can be duplicated for security and to guarantee continuity of service.

The communications terminal 10 is connected to the session manager 11 to request a connection to a remote unit 14. To preserve confidentiality, the terminal 10 is connected to the session manager 11 by means of a secure transmission using an existing transmission protocol to encrypt calls, such as the HTTPS (HyperText Transfer Protocol Secured) protocol for a web server, or using a secure local network such as a LAN (local area network), a WAN (wide area network) interconnecting a plurality of local area networks, a corporate private network, etc.

The session manager 11 is connected to one or more modems 12 enabling simultaneous transmission of data via different connections. The various connections can be made at various serial ports, for example an RS232 port. Each modem 12 is connected to a session manager 11 and to said telecommunications network 100.

Said database contains a list of the users of the terminals 10 that can connected to the session manager 11, a list of profiles for the rights associated with those users, a list of the various security devices 13 and the various remote units 14 for each security device 13, and a list of the various access means to said security devices 13 and remote units 14, such as telephone numbers, IP (Internet Protocol) addresses, etc.

Said security device 13 can receive from a session manager 11 a request for connection to a remote unit 14. It can receive and recognize the identification of a remote unit 14. It is configured to receive a request for connection between one or more session managers 11 and one or more remote units 14. It is also configured to set up a connection to one or more remote units 14, and the same security device 13 can be connected to more than one remote unit. To enable secure transmission between a terminal 10 and a defined remote unit 14, each connection is referenced by an identified secure working session corresponding to a communication session. Each secure working session with a security device 13 is identified by a communication session. Also, a second security device 13 can be connected to a port of a first security device 13, for example an Ethernet port.

Moreover, a security device 13 can be connected to one or more modems 12′ for connection and transmission to a telecommunications network 100. The various connections can be made at various serial ports, for example an RS232 port. Each modem 12′ is connected to a security device 13 and to a telecommunications network 100, for example the public switched telephone network (PSTN), an ADSL (asymmetric digital subscriber line) transmission network, etc.

The steps of the method of the invention connect a user of a terminal 10 to a session manager 11; for example, the user accesses a portal providing access to the service or a home page, or simply accesses directly a list of existing or authorized remote units 14. The terminal 10 receives in return an authentication request, for example a request for the user to enter a login and password. Once the user has been authenticated, the user can select a remote unit 14 to which a connection is to be made. The session manager 11 consults the user's profile to check that user's right to access a selected remote unit 14 (administrator, switch unit on/off, etc.) or to access only some of the remote units 14. If authorized, the user then requests that a call be set up to said defined remote unit 14.

The method therefore includes a step of connecting the terminal 10 to the session manager 11 to define a remote unit 14 to which said terminal 10 is going to transmit data. The session manager 11 is configured to receive from the communications terminal 10 a request for connection to a defined remote unit 14.

The session manager 11 automatically commands opening of a communication session for setting up a connection via the communications network 100 to a security device 13 connected to said remote unit 14 defined by the terminal 10. The step of opening a communication session is not obligatory if a connection has already been set up between the same session manager 11 and the same security device 13. A specific identification number is assigned to said communication session and saved in the database, enabling the various connection requests to be distinguished from each other. The session manager 11 looks up the information necessary for setting up the connection in a database, for example a telephone number of a modem 12′ to be called on a geographical site of the remote unit 14, an IP address, or an input port number of a terminal local to the site connected to the security device 13. With this information, the manager 11 sets up a connection to a security device 13 corresponding to the remote unit 14 defined by the user. For example, the communication session is a connection set up with a standardized point-to-point protocol (PPP) enabling transmission of data via a modem, for example using a serial port. The security device 13 validates the connection after authentication of the manager 11.

To create a first secure session SSH1 using a secure transmission tunnel between the manager 11 and said terminal 10, the session manager 11 automatically commands an SSH security software application of the terminal 10. The terminal 10 is configured with a security application for creating said secure transmission tunnel to a session manager 11. A specific identification number is assigned to said secure session SSH1 and saved in the database, enabling the various transmissions to the session manager 11 to be distinguished from each other. Said secure session SSH1 is associated with said communication session, identified at the time of the request to connect said terminal 10 to said security device 13 connected to the defined remote unit 14. For each communication session the session manager 11 creates a first secure transmission tunnel to a terminal 10. Consequently, multiple secure transmission tunnels can be created from the same communications terminal 10 to one or more session managers 11.

Opening the secure session SSH1 with the security application of the terminal 10 is automated and requires no user intervention. The session manager automatically commands said security application of the communications terminal 10 to create said first secure transmission tunnel. Because of this, the user does not know and has no access to any information for setting up the connection to said remote unit 14 and making transmission to it secure, such as a telephone number, an IP address of a security device, etc.

Moreover, said first secure session SSH1 is independent of the initial connection enabling the user of the terminal 10 to define a remote unit 14 to which a connection is to be made.

The session manager 11 also commands creation of a second secure session SSH2 with said security device 13 connected to said defined remote unit 14 via a second secure transmission tunnel between the session manager 11 and said security device 13. Said second secure transmission tunnel is created between the session manager 11 and the security device 13 for said identified communication session. Once again, a specific identification number is assigned to said secure session SSH2 and saved in the database, enabling the various transmissions to the session manager 11 to be distinguished from each other. The session is made secure by an existing authentication method, for example using an asymmetrical key encryption algorithm. Under such circumstances, only the manager 11 holds a private key for making the transmission to the security device 13 secure. The public key of the security device 13 enables validation by authentication of the call between the manager 11 and said security device 13. The session manager 11 commands the connection to a remote unit 14 via said security device 13.

The method of the invention then includes a step of transmitting data between a terminal 10 and a remote unit 14. The session manager 11 is able to create automatically and manage simultaneously one or more secure working sessions with a terminal 10 and with a remote unit 14. The security device 13 is able to set up automatically and simultaneously one or more communication sessions with said session manager 11. Once a communication session has been set up, said security device 13 is configured to set up a secure working session with said session manager 11.

The secure session SSH2 is also opened automatically and without user intervention. Because of this, the user does not know and has no access to any information for setting up the connection and making it secure or for transmission to the security device 13, such as a public encryption key enabling secure exchange between a session manager 11 and a security device 13 or a private key known only to said session manager 11.

The manager 11 monitors a secure working session SSH corresponding to the two secure transmission tunnels, namely a tunnel SSH1 to a terminal 10 and a tunnel SSH2 to a security device 13, via modems 12 and 12′. The pair SSH1 and SSH2 is strongly identified for the same secure working session to enable reliable and secure transmission between the terminal 10 and a remote unit 14 via a security device 13. The session manager 11 creates a first secure transmission tunnel to the terminal 10 for each communication session. Similarly, a second secure transmission tunnel to a security device 13 is created for each communication session. Said security application of the terminal 10 monitors the transmission of data in a secure working session using the transmission tunnels to a remote unit 14 via the unsecure public telecommunications network 100.

As previously mentioned, the connection protocol is secure, with authentication of the user, the terminals and the units connected. The algorithms used guarantee the confidentiality of data transmission. No password is transmitted in clear during the sessions and the sessions themselves are encrypted.

A computer program of the session manager 11 manages two secure sessions SSH1 and SSH2 simultaneously for a communication session. Said computer program includes code portions for executing the various functional steps monitored by the session manager 11. In particular, it enables reception of a connection request and creation and management of a secure working session.

For security reasons, and in particular if the terminal 10 is not connected to the session manager 11 by a protected network, the secure session SSH1 can be of the same kind as the secure session SSH2, with exchange of data encrypted using a public key known to the terminal 10. Similarly, a secure working session with a remote unit 14 can be set up if that unit is not locally connected to a security device 13.

One or more communication sessions and one or more secure working sessions with one or more security devices 13 are created and then monitored by a session manager 11. A session manager 11 can create a plurality of communication sessions with different security devices 13. Moreover, a single communication session between a session manager 11 and a security device 13 can set up a plurality of secure working sessions with different communications terminals 10 or different remote units 14, by means of strong identification of the secure sessions. Said session manager 11 can create one or more secure working sessions for the same communication session.

What is more, a plurality of terminals 10 can be connected to the same remote unit 14, for example to enable remote maintenance by different technical experts. Once the communication session has been set up a plurality of secure working sessions with a security device 13 and with the same remote unit 14 can be set up, guaranteeing separation of the various transmissions of identified data.

The two secure sessions being active, a secure working session is therefore created between a terminal 10 and a remote unit 14 via the modems 12 and 12′, a session manager 11 and a security device 13. Accordingly, using the same functions as a local terminal situated on the same geographical site as the remote unit 14, the terminal 10 can then send data to the remote unit 14, such as a command to be executed, modify or supervise a program, view an operation, etc., in the same way as if it were situated locally to said unit, so guaranteeing transmission security.

A single communication session sets up a plurality of simultaneous transmissions to the same security device 13. Consequently, if a user of a terminal 10 wishes to set up a call to another remote unit, the security device 13 of which is already connected to the corresponding session manager 11, only a new secure working session SSH with the corresponding security device 13, consisting of the two transmission tunnels SSH1 and SSH2, is commanded by the session manager 11. What is more, a plurality of security devices 13 can be connected in series to enable access to a greater number of remote units 14 in the same communication session.

Each of the various connections between a session manager 11 and a security device 13 is identified by a different secure session, corresponding to different terminals 10 each communicating with a remote unit 14. Said secure transmission management system therefore uses multiple SSH sessions, by means of strong and reliable identification of the pair SSH1 and SSH2. A single communication session between a session manager 11 and a security device 13 enables simultaneous transmission by different terminals 10 to different remote units 14 attached to the same security device 13, as well as guaranteeing the reliability and the compartmentalization of the various transmissions. Said session manager 11 creates one or more secure working sessions for a communication session.

The system and the method of the invention therefore provide multiple communication session management. The session manager 11 can create a plurality of communication sessions with different security devices. The session manager 11 manages routing to the various connections, for example IP routing. After a communication session has been set up, a secure session SSH is routed dynamically to the correct communication session. Moreover, to reduce the occupancy of the telecommunications network 100, a plurality of security devices 13 can be connected in series to increase the number of remote units 14 accessible in the same communication session.

To disconnect the communications terminal 10, the user activates a command for ending communication with the remote unit 14. The security software application SSH running on the terminal 10 is then closed. On closure of this application SSH on the terminal 10, the session manager 11 commands closure of the first secure session SSH1 with said terminal 10. The session manager 11 also commands closure of the second secure session SSH2 with the security device 13 corresponding to the remote unit 14. The working session SSH, corresponding to the two sessions SSH1 and SSH2, is then closed in the session manager 11.

The closing of a working session can also be commanded by inactivity of the user of the terminal 10 (time-out). Depending on the type of unit, the security device 13 and/or the remote unit 14 can also manage a time-out delay themselves. The secure session SSH2 is then closed and the session manager 11 commands closure of the secure session SSH1.

At the time of closure, the session manager 11 checks that no other secure SSH session has been set up with the same security device 13. If there are no other secure sessions SSH in progress, said manager 11 breaks the connection and ends the communication session with said security device 13.

All the data relating to a communication session and/or a secured working session is saved in said database for statistical purposes or for verification in event of error or breakdown, in particular by means of the different identification numbers.

Said system and method according to the invention therefore enable a security chain to be set up through the session manager 11, with no access to the security functions by the user of the terminal 10. For example, only the session manager 11 holds a private security key, which is never sent anywhere else.

A computer program comprising code portions executes the various steps of the method defined above and is stored on a computer-readable storage medium.

What is claimed is:

1. A method of managing secure transmission to a remote unit, comprising the steps of:
connecting at least a terminal to at least a session manager to define at least a remote unit;
said session manager automatically commanding opening of a communication session for setting up a connection to at least a security device connected to said defined remote unit;
said session manager automatically checking at least a security application of the terminal to create at least a first secure transmission tunnel associated with said communication session;
said session manager creating at least a secure working session with said security device for said communication session that has been set up; and
transmitting data between the terminal and the remote unit.

2. The management method according to claim 1, wherein said first secure transmission tunnel to said terminal is created by said session manager for each communication session.

3. The management method according to claim 1, wherein a second secure transmission tunnel to said security device is created by said session manager for each communication session.

4. The management method according to claim 1, wherein each secure working session with said security device is identified by a communication session.

5. The management method according to claim 1, wherein one or more communication sessions, one or more secure working sessions, with one or more security devices are created simultaneously by said session manager, separately or in combination.

6. The management method according to claim 1, wherein said session manager creates one or more communication sessions with different security devices.

7. The management method according to claim 1, wherein said session manager creates one or more secure working sessions for a communication session.

8. A computer program comprising code portions for executing one of the steps of the method according to claim 1.

9. A computer-readable storage medium on which said computer program according to claim 8 is stored.

10. A system for managing secure transmission to a remote unit, comprising:
at least a session manager adapted to receive from at least a communications terminal at least a request for connection to at least a defined remote unit and adapted to create and simultaneously and automatically manage at least a secure working session with said terminal and said remote unit; and
at least a security device corresponding to said defined remote unit and adapted to set up simultaneously and automatically at least a communication session and then said secure working session with said session manager.

11. A session manager adapted to be used in a system according to claim 10, the session manager being configured to receive at least a connection request from at least a terminal for communication with at least a remote unit, to manage and store in a database at least an identification of said connection, and to transmit data to at least a security device connected to said remote unit.

12. A computer program comprising code portions for executing functional steps monitored by the session manager according to claim 11.

13. A security device adapted to be used in a system according to claim 10, the security device being configured to receive at least a request for connection between a session manager and at least a remote unit.

14. A communications terminal adapted to be used in a system according to claim 10, the communications terminal being configured with at least a security application for the creation of at least a secure transmission tunnel to at least a session manager.

15. A communications terminal according to claim 14, wherein said security application monitors transmission of data via said secure transmission tunnel to at least a remote unit.
